(19) United States
(12) Patent Application Publication
(10) Pub. No.: US 2011/0314715 A1
(43) Pub. Date: Dec. 29, 2011

(54) SUPPORTING POLE FOR ADVERTISING STRIPS, PANELS, FLAGS OR BANNERS

(76) Inventor: Domenico Tomacelli, Cerignola (FG) (IT)

(21) Appl. No.: 13/154,655

(22) Filed: Jun. 7, 2011

(30) Foreign Application Priority Data
Jun. 11, 2010 (IT) MI2010A001059

(51) Int. Cl. G09F 15/00

(52) U.S. Cl. 40/607.01

(57) ABSTRACT

The supporting pole has a metallic inner structure (1) and an outer lining (2) extending over the entire length of the pole and presenting at least one vertical fissure (2′) extending from the top to a point next to the base of the pole, and is characterized by the fact of comprising:
An inner belt (3) mounted on a driving pulley (4) set up next to the base of the pole, and on a return pulley (5) set up next to the top of the pole;
Two inner slides (6, 7) capable of sliding along at least one rail (18) set side by side to said belt, where a first one (6) of said slides is in an upper position and anchored to a section of said belt;
At least two elements (8, 9) destined for a direct or indirect support of the advertising article, sliding within said fissure (2′), having a part inside said lining fastened in a removable manner to the first and the second slide, respectively, and an outer part having anchoring points for the advertising article or brackets (10, 11) for supporting the same.
A device for activating the driving pulley, which is provided with a reducer mechanism (12, 13) and a hand-operated crank (14) capable of controlling the rise or descent of the slide (6) anchored to the belt.

The object of the invention is a supporting pole for advertising articles, especially a pole for carrying advertising strips, panels, flags and banners.

### STATE OF THE ART

At this time, the roadside exhibition of advertising strips, panels, flags or banners does, in a great majority of cases, not utilize supports or hook-ups specifically conceived for this purpose, but pre-existing means provided for other purposes, such as lanterns, balconies, trees etc., to which the article is anchored by ropes or metallic frames.

Because in the mentioned cases the operations of installing, updating, cleaning, restoring and removing the advertising articles involve typical risks of height (persons or materials dropping from above, etc.) and costs deriving from the use of vehicles fitted with lifting equipment, the author of this invention has, for overcoming these drawbacks, already conceived a pole specifically designed for supporting advertising articles, as described in the Italian patent no. 1.355.075. This pole provides, in its interior, the presence of a cursor that is capable of sliding along a guide running from the top of the pole to a point close to its base and anchored by a screw and nut coupling system to an endless screw inside the pole, which controls its motions; a metallic support for advertising articles, capable of sliding along a vertical fissure along the lining of the pole; and an inner element in the pole attached to the cursor and an outer element, preferably in the shape of a fork with three anchoring points for the advertising article, set in an upper, middle and lower section.

### SCOPES OF THE INVENTION

The present invention proposes to realize a pole as above, of an improved type in regards to its production costs, as well as of a simplified form and having a better modularity of certain constructive components such as the cursor and the metallic support anchored to the same.

### ABSTRACT OF THE INVENTION

The pole carrying advertising articles and especially advertising strips, flags or banners according to the invention further provides, as for the pole mentioned above, an inner metallic structure and an outer lining extending over the entire length of the pole and featuring at least one vertical fissure that extends from the top near to the base of the pole, and is characterized by the fact of comprising:
An inner belt mounted on a driving pulley set up next to the base of the pole, and a transmission pulley set up next to the top of the same;
Two inner slides capable of sliding along at least one rail running side by side to said belt, where one of said slides is essentially in an upper position and anchored to a branch of said belt;
At least two elements destined for a direct or indirect support of the advertising article, sliding within said fissure and having an inner part of said lining fastened in a removable manner to the first and to the second slide, respectively, and an outer part fitted with anchoring points for the advertising article, or with supporting brackets for the same.
An actuating device for the driving pulley, fitted with a reducing mechanism and a hand-operated crank, capable of commanding the rising and lowering of the slide anchored to the belt.

### LIST OF DRAWINGS

The characteristics and advantages of the invention will become better evident from the following description referring to examples of embodiment of a non-limiting nature, made with reference to the attached drawings, whose figures are schematically showing:

FIG. 1: an elevated sectional view of a pole according to this invention.

FIG. 2: an enlarged prospective view of the part “a” of FIG. 1.

FIG. 3: an enlarged prospective view of the part “b” of FIG. 1.

FIG. 4: an enlarged prospective view of the part “c” of FIG. 1.

FIG. 5: an enlarged prospective view of the part “d” of FIG. 1.

FIG. 6: a horizontal sectional view of the pole, taken along the section A-A and enlarged.

FIG. 7: a profile of each support 8 and 9 in the FIGS. 1, 4, 5 and 8.

FIG. 8: a prospective view of the slides 6 and 7, assembled for the case of supporting advertising panels or banners.

FIG. 9: a view of a pole according to the invention, used for supporting an advertising panel.

FIG. 10: a view of two poles according to the invention, used for supporting an advertising strip.

FIG. 11: a view of the pole according to the invention, used for supporting a banner or a flag.

### DESCRIPTION OF THE PREFERRED FORMS OF EMBODIMENT

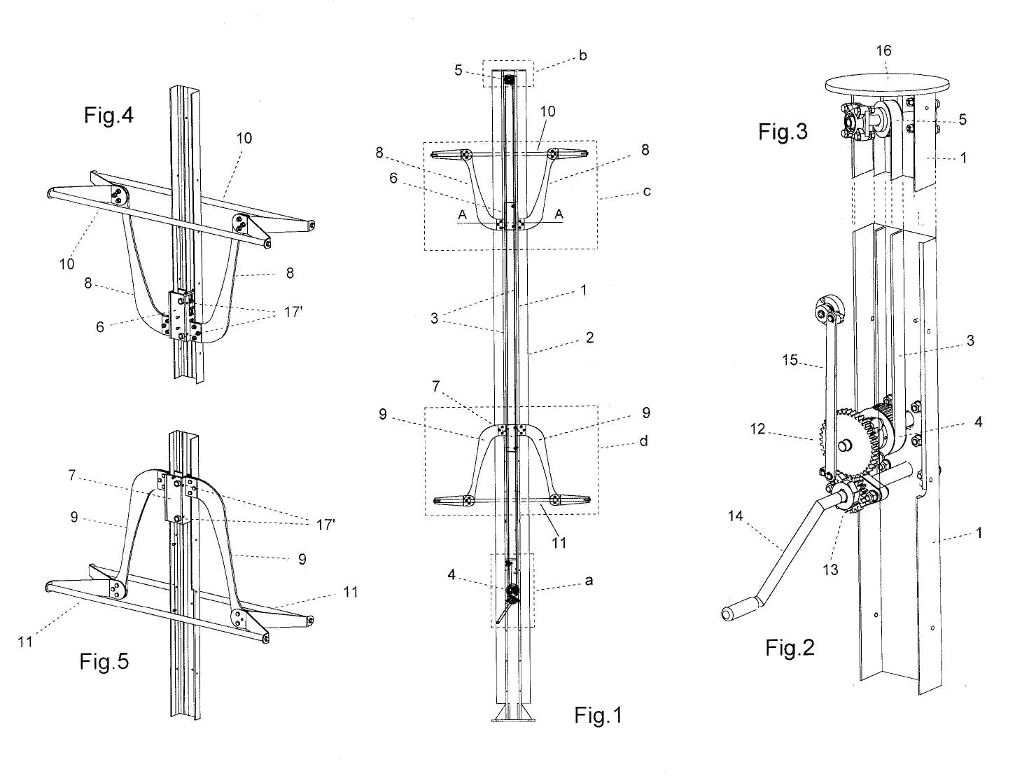

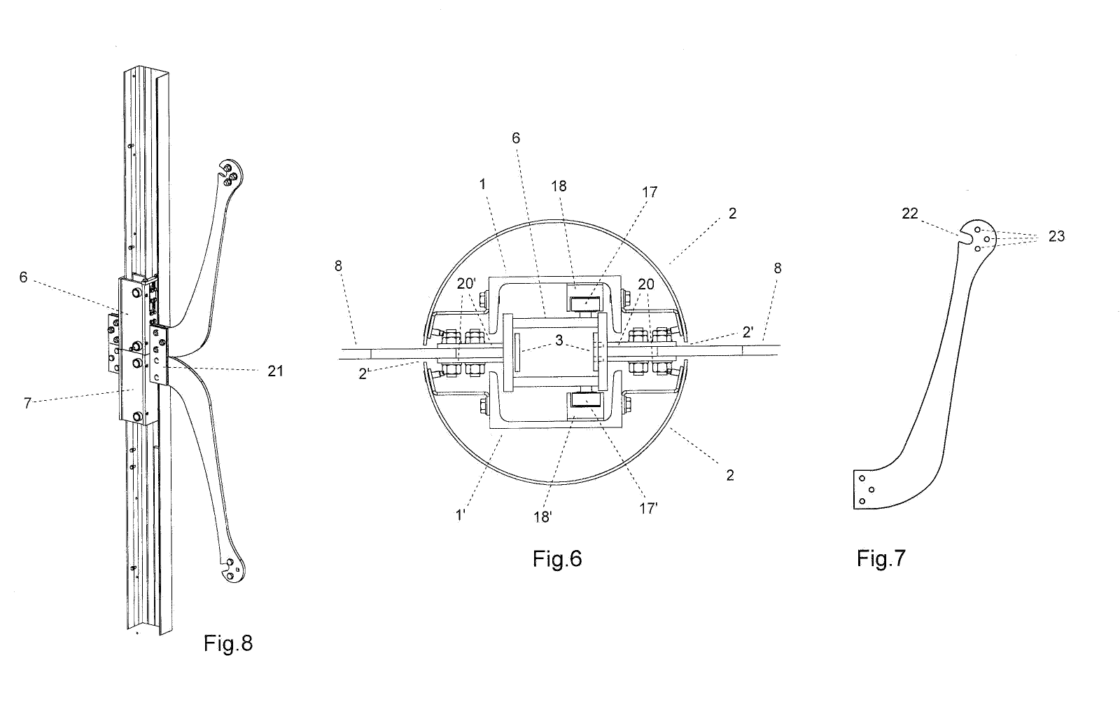

FIG. 1 schematically shows a vertical sectional view of a pole carrying advertising strips, panels, flags and banners. The various elements marked out in the same have the following meaning:
1. One of two inner metallic posts (posts 1 and 1′ of FIG. 6), with a C-shaped section extending over the entire length of the pole;
2. An outer lining (shown in a section in FIG. 6) presenting two opposing fissures extending from the top to next to the base of the pole (see the fissures 2′ of FIG. 6);
3. A belt mounted on a driving pulley 4 set up next to the base of the pole and on a return pulley 5 set up next to the top of the same;
6 and 7: Slides capable of sliding along two rails set up side by side to said belt (rails 18 and 18′ of FIG. 6), where the upper slide 6 is anchored to a section of the belt, and the lower slide 7 is capable of freely sliding along the rails (or of coupling to the first slide, in the case of a pole utilized for supporting horizontal strips or panels, as shown below with reference to the FIGS. 8, 9 and 10);
8 and 9: Metallic supports, each sliding within one of the said fissures, having an inner part inside the lining that is fastened in a removable fashion to one of said slides 6 and 7, respectively, and an outer part carrying anchoring points for the brackets 10 and 11, respectively, which support a banner or flag (not evidenced in the figure).

The FIGS. 2, 3, 4 and 5 represent enlarged prospective views of the parts of FIG. 1, each including the dashed contour of the rectangles a, b, c and d, albeit views wherein the lining 2 has been omitted for enhanced representative clarity.

In particular, FIG. 2 evidences, next to the pulley 4 and the belt 3, the presence of:
A reducer mechanism constituted of the gears 12 and 13;
A manually operated crank 14;
A ratchet mechanism capable of allowing the gears' rotation in only one direction. The mechanism can be deactivated manually.

The FIG. 3 shows the pulley 5 fastened to the post 1 and set up immediately below a circular plate 16 that constitutes the top of the pole and is designed to join up with the lining.

The FIGS. 4 and 5 show:
The shape of the brackets 10, 11 and the manner of their connection to the supports 8 and 9;
The connecting manner of the supports 8 and 9 (whose modular form is more completely represented in FIG. 7) to the brackets 10 and 11 and the slides 6 and 7;
The structure, resembling a box-like sleeve, of the slides 6 and 7, and the presence of a pair of roller bearings 17 on the same, which are destined to slide on a rail 18′, not represented in the FIGS. 4 and 5 but evidenced in FIG. 6 (as can be gathered from FIG. 6, each slide also has a second pair of bearings 17, in a position opposite to that of the bearings 17′).

The FIG. 6 shows a view of the pole of FIG. 1 according to a horizontal section taken along the line A-A of the same figure. The following is particularly highlighted in the same;
The outer lining 2 and the corresponding opposed fissures 2′;
The two posts 1 and 1′ with a C-shaped section, and the ways of anchoring the lining 2 to said posts;
The two rails 18 and 18′ fastened to the posts;
The sectional view of the slide 6 and the lower bearings of the two pairs of bearings 17 and 17′ sliding in the rails 18 and 18′.
The presence of two pairs of flaps 20 and 20′ projecting from the slide 6, on which the lower extremities of the supports 8 are anchored.
The two sections of the belt 3, with the right hand section anchored to the slide.

As refers to the structure of the lower slide 7, it fully resembles that of slide 6, with the difference that it happens to be turned upside down with respect to that of 6 (refer to the fastening flaps to the supports 9, which happen to be positioned above, contrary to those of the slide 6, that are positioned below). Moreover, the slide 7 happens to be released from both sections of the belt, so as to be able to freely slide along the rails 18 and 18′. In this manner, when the brackets 11 are anchored to the lower border of a flag or banner (see the example of FIG. 11), the weight of the guide assembly 7, the supports 9 and brackets 11 keep it extended.

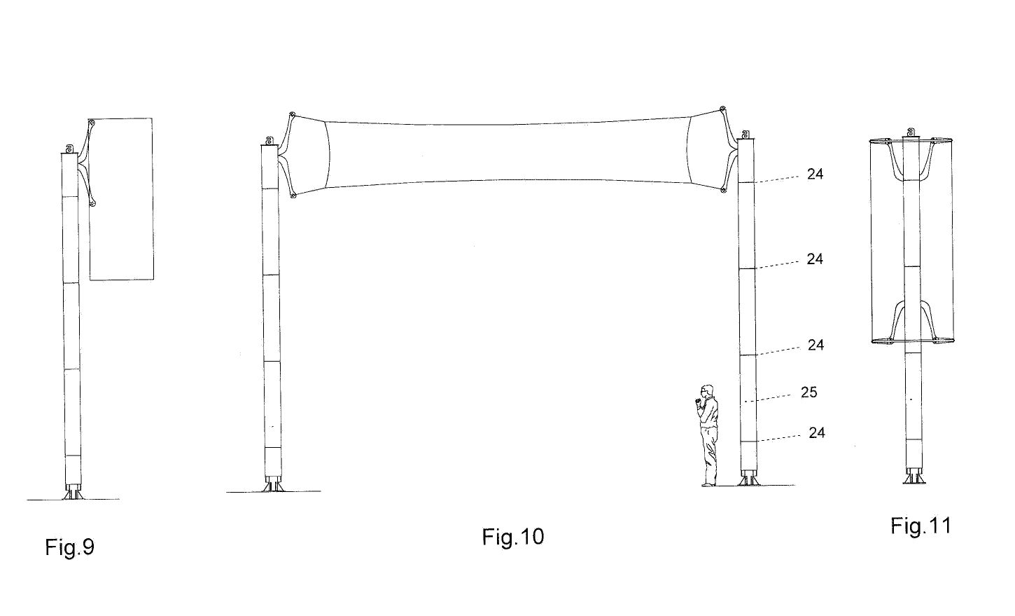

The different positioning of the flaps 20 and 21 in the two slides is justified by the fact that the pole according to the invention can be utilized, beside for supporting flags or banners, (see FIG. 11), also for supporting panels (see FIG. 9) or horizontal strips (see FIG. 10). In these two latter cases the brackets 10 and 11 are in fact lacking, the number of the supports 8 and 9 can be reduced from four to only two positioned on the same side of the pole, and the lower slide is anchored to the upper one, for instance by a plate as shown in FIG. 8 (see the plate 21 simultaneously engaged with the flaps set to the right of the slides 6 and 7). The supports 8 and 9 thus happen to be joined to each other and an activation of the driving pulley provokes their simultaneous shifting motion.

The possible modes of utilizing the invention are described as follows.

In order to install a horizontal strip (FIG. 10), it is necessary to set up two poles at a certain distance (for instance at both sides of a road), and to proceed in accordance with the following steps:
Allow the slides to descend to the position of their lower stop, by hand-operating the driving pulley while releasing its locking ratchet mechanism;
Disassemble, if installed, the brackets fastened to the supports 8 and 9;
Disassemble, if installed, that one of the two supports 8 and that one of the two supports 9 that is not involved in affixing the strip;
Where necessary, connect the two slides by means of the plate 21;
Fasten the four elastic tie rods of the strip to the anchoring points indicated by “22” in FIG. 7.
Raise the slides, by manual action, up to the position of their upper stops.

The FIG. 10 shows, for exemplifying purposes, the way two poles with an advertising strip mounted on them appear according to the invention.

In order to install an advertising panel instead of a strip, the ways of installation are similar to those in the previous case. The only difference is constituted by the way of fastening the panel to the support. In this case, the panel will be fastened by screws to the anchoring points indicated by “23” in FIG. 7. FIG. 9 shows, for exemplifying purposes, how a pole according to the invention looks with an advertising panel installed on the same.

In case flags or banners are to be installed, one proceeds in accordance with the following steps:
Allow the slides to descend to the position of their lower stop, by hand-operating the driving pulley while releasing its locking ratchet mechanism;
If necessary, disconnect the two slides by disassembling the connecting plate 21;
If necessary, symmetrically mount the supports 8 and 9 on the slides 6 and 7, by engaging their respective anchoring systems;
Fasten the brackets to the supports by screws, while using the anchoring points “23” of FIG. 7 (the tubular rods of the brackets are mounted along with the flag or banner);
Raise the slide 6 up to the position of its upper stop.

As regards the representations of the FIGS. 9, 10 and 11, it is pointed out that the horizontal lines following each other along the vertical length of the pole (Lines 24 of FIG. 10) are there to indicate that the outer lining of the pole is subdivided into several vertical sections, each of a semi-cylindrical form. One of these sections, which is set next to the base of the pole (See the section indicated by 25 in FIG. 10) is destined to be removed whenever it happens to be necessary to actuate the driving mechanism of the driving pulley and to effect the removal and/or the new installation of an advertising article.

The embodying examples previously described for illustrative and non-limiting purposes may be provided with modifications, adaptation, variants and substitutions of elements with others of a functionally equivalent kind, without thereby abandoning the scope of the claims that follow.

1. Supporting pole for advertising articles and in particular for advertising strips, panels, flags and banners, having a metallic inner structure (1) and an outer lining (2) extending over the entire length of the pole and presenting at least one vertical fissure (2′) extending from the top to a point next to the base of the pole, characterized by the fact of comprising:
An inner belt (3) mounted on a driving pulley (4) set up next to the base of the pole, and on a return pulley (5) set up next to the top of the pole;
Two inner slides (6, 7) capable of sliding along at least one rail (18) set side by side to said belt, where a first one (6) of said slides is in an upper position and anchored to a section of said belt;
At least two elements (8, 9) destined for a direct or indirect support of the advertising article, sliding within said fissure (2′), having a part inside said lining fastened in a removable manner to the first and the second slide, respectively, and an outer part having anchoring points for the advertising article or brackets (10, 11) for supporting the same.
A device for activating the driving pulley, which is provided with a reducer mechanism (12, 13) and a hand-operated crank (14) capable of controlling the rise or descent of the slide (6) anchored to the belt.

2. Supporting pole for advertising articles as in claim 1, characterized by the fact that said supporting elements (8, 9) have a modular structure and are installed on the upper and on the lower slide, respectively, in a position overturned to each other.

3. Supporting pole for advertising articles as in claim 1, characterized by the fact that said slides (6, 7) have a modular structure and are installed in a manner overturned to each other.

4. Supporting pole for advertising articles as in claim 1, characterized by the fact that the second (7) of said slides, assigned to a lower position, is destined to freely slide along said rail when the pole is utilized for supporting vertical flags or banners, while it is destined to be anchored to the upper slide (6) when the pole is utilized for supporting horizontal strips or panels.

5. Supporting pole for advertising articles as in claim 1, characterized by the fact that the fissures (2′) present in the outer lining (2) and in the number of two and in a position opposite to the axis of said pole.

6. Supporting pole as in claim 1, characterized by the presence of a ratchet mechanism (15) that is capable of being manually unlocked, suitable for rendering the rotation of the driving pulley possible in only one direction, and such as to keep advertising strips, panels, flags and banners locked to a predetermined height until a new operator intervention.

7. Supporting pole for advertising articles as in claim 1, characterized by the fact that the outer lining (2) happens to be subdivided into several vertical sections of a semi-cylindrical form, where one (25) of these sections, set up next to the base, is destined to be removed anytime it proves necessary to activate the driving mechanism of the driving pulley and to effect the removal and/or a new installation of an advertising article.

8. Supporting pole for advertising articles as in claim 4, characterized by the fact that the equipment that allows supporting the strips, panels, flags and banners can be reconfigured by a partial or total mounting and dismounting of the various components (supports, brackets, anchors of the slides between them) depending on the specific application.
